(19) United States
(12) Patent Application Publication
(10) Pub. No.: US 2012/0152823 A1
(43) Pub. Date: Jun. 21, 2012

(54) AROMATIC POLYSULFONE RESIN POROUS MEMBRANE

(75) Inventors: Satoshi Okamoto, Tsukuba-shi (JP); Yusaku Kohinata, Tsukuba-shi (JP)

(73) Assignee: Sumitomo Chemical Company, Limited, Tokyo (JP)

(21) Appl. No.: 13/393,534

(22) PCT Filed: Sep. 14, 2010
(86) PCT No.: PCT/JP2010/065804

§ 371 Date: Feb. 29, 2012

(30) Foreign Application Priority Data
Sep. 29, 2009 (JP) 2009-224272

(51) Int. Cl. B01D 71/68

(52) U.S. Cl. 210/500.23; 521/134

(57) ABSTRACT

The present invention relates to a porous membrane which contains aromatic polysulfone resin that has a reduced viscosity of 0.56-0.78 dL/g, and a hydrophilic polymer.

### TECHNICAL FIELD

The present invention relates to a porous membrane using aromatic polysulfone resin.

Priority is claimed on Japanese Patent Application No. 2009-224272, filed Sep. 29, 2009, the content of which is incorporated herein by reference.

### BACKGROUND ART

As porous membranes used in filtration such as ultrafiltration and microfiltration, membranes using various resins as their material have been studied. Among these, porous membranes made of aromatic polysulfone resin are excellent in heat resistance and solvent resistance, but as aromatic polysulfone resin alone has poor water permeability, and is unsuited to filtration of aqueous fluids, studies have mainly focused on intermixture of hydrophilic polymers in order to improve this. For example, JP-2006-230459-A (Patent Document 1) describes a porous hollow-fiber membrane using aromatic polysulfone resin and polyvinylpyrrolidone as the hydrophilic polymer, and presents an example of a porous hollow-fiber membrane using aromatic polysulfone resin which has a reduced viscosity of 0.36, 0.48, or 0.52.

### CITATION LIST

### Patent Documents

Patent Document 1: JP-2006-230459-A

### DISCLOSURE OF INVENTION

### Problems to be Solved by the Invention

Porous membranes which experience clogging and reduced filtration efficiency as a result of prolonged use in filtration are usually physically cleaned by causing backflow of air or water in order to eliminate clogging, but when porous membranes made of conventional aromatic polysulfone resin and a hydrophilic polymer are subjected to the aforementioned physical cleaning, excessive pressure is imposed, causing damage such as tears or ruptures. Moreover, in cases where cleaning is insufficient with the aforementioned physical cleaning, chemical cleaning is further conducted using an alkali aqueous solution such as sodium hydroxide aqueous solution or a chlorine aqueous solution such as sodium hypochlorite aqueous solution, but damage such as tears or ruptures also may occur during this chemical cleaning. Thus, the purpose of the present invention is to offer a porous membrane which is made of aromatic polysulfone resin and hydrophilic polymer, and which is high in strength and chemical resistance so as to enable it to withstand physical cleaning and chemical cleaning.

### Means to Solve the Problems

In order to achieve the aforementioned objective, the present invention offers a porous membrane containing aromatic polysulfone resin that has a reduced viscosity of 0.56-0.78 dL/g, and a hydrophilic polymer.

That is, the present invention has the following aspects.

(i) A porous membrane, comprising aromatic polysulfone resin that has a reduced viscosity of 0.56-0.78 dL/g, and a hydrophilic polymer.

(ii) The porous membrane according to (i), wherein reduced viscosity of the aforementioned aromatic polysulfone resin is 0.65-0.78 dL/g.

(iii) The porous membrane according to (i), wherein reduced viscosity of the aforementioned aromatic polysulfone resin is 0.70-0.78 dL/g.

(iv) The porous membrane according to any one of (i)-(iii), wherein the aforementioned aromatic polysulfone resin is resin which has a repeating unit represented by the following formula (1):

-Ph¹-SO₂-Ph²-O— (1)

In the formula, Ph¹ and Ph² each independently represents a phenylene group, and hydrogen atoms of the aforementioned phenylene groups may each be independently substituted with an alkyl group, an aryl group, or a halogen atom.

(v) The porous membrane according to any one of (i)-(iv), wherein the hydrophilic polymer is polyvinylpyrrolidone.

(vi) The porous membrane according to any one of (i)-(v), which is a hollow-fiber membrane.

### Effect of the Invention

In addition to obtaining excellent heat resistance, solvent resistance, and water permeability by using aromatic polysulfone resin and hydrophilic polymer as its material, the porous membrane of the present invention is high in strength and chemical resistance, enabling it to withstand physical cleaning and chemical cleaning, and may therefore be suitably used in aqueous fluid filtration such as ultrafiltration and microfiltration.

### EMBODIMENTS FOR CARRYING OUT THE INVENTION

The porous membrane of the present invention contains aromatic polysulfone resin and hydrophilic polymer.

Aromatic polysulfone resin is resin which has a repeating unit including a bivalent aromatic group (the residual group constituted by removing two hydrogen atoms bound to an aromatic ring from an aromatic compound) and a sulfonyl group (—SO₂—). From the standpoints of heat resistance and chemical resistance, it is preferable that the aromatic polysulfone resin have the repeating unit represented by the formula (1) below (hereinafter sometimes referred to as “repeating unit (1)”), and it may also have other repeating units such as the repeating unit represented by the formula (2) below (hereinafter sometimes referred to as “repeating unit (2)”) or the repeating unit represented by the formula (3) below (hereinafter sometimes referred to as “repeating unit (3)”). The aromatic polysulfone resin preferably contains 50-100 mol %, and more preferably 80-100 mol %, of the repeating unit (1) relative to the total of all repeating units.

-Ph¹-SO₂-Ph²-O— (1)

Ph¹ and Ph² each independently represents a phenylene group. Hydrogen atoms of the aforementioned phenylene groups may each be independently substituted with an alkyl group, an aryl group, or a halogen atom.

-Ph³-R-Ph⁴-O— (2)

Ph³ and Ph⁴ each independently represents a phenylene group. Hydrogen atoms of the aforementioned phenylene groups may each be independently substituted with an alkyl group, an aryl group, or a halogen atom. R represents an alkylidene group, an oxygen atom, or a sulfur atom.

-(Ph⁵)ₙ-O— (3)

Ph⁵ represents a phenylene group. Hydrogen atoms of the aforementioned phenylene groups may each be independently substituted with an alkyl group, an aryl group, or a halogen atom. n represents an integer from 1-3. In the case where n is 2 or more, the Ph⁵ which exists in a plurality may be mutually the same or different.

The phenylene group represented by any one of Ph¹-Ph⁵ may be a p-phenylene group, a m-phenylene group, or an o-phenylene group, but a p-phenylene group is preferable. Examples of the alkyl group which may substitute a hydrogen atom of the aforementioned phenylene groups include a methyl group, an ethyl group, a n-propyl group, an isopropyl group, a n-butyl group, an isobutyl group, an s-butyl group, and a t-butyl group, and the carbon number thereof is usually 1-5. Examples of the aryl group which may substitute a hydrogen atom of the aforementioned phenylene groups include a phenyl group, a 1-naphthyl group, a 2-naphthyl group, and a p-toluoyl group, and the carbon number thereof is usually 6-15. Examples of the alkylidene group represented by R include a methylene group, an ethylidene group, an isopropylidene group, and a 1-butylidene group, and the carbon number thereof is usually 1-5.

The reduced viscosity of the aromatic polysulfone resin is 0.56-0.78 dL/g, preferably 0.65-0.78 dL/g, and more preferably 0.70-0.78 dL/g. When reduced viscosity is outside of the aforementioned range, the strength and chemical resistance of the obtained porous membrane are insufficient. Moreover, when reduced viscosity exceeds the aforementioned upper limit, workability during manufacture of the porous membrane is insufficient.

The aromatic polysulfone resin can be suitably produced by polycondensing corresponding aromatic dihalogenosulfone compounds and aromatic dihydroxy compounds in an organic polar solvent using an alkali metal salt of carbonic acid as the base. For example, a resin having the repeating unit (1) can be suitably produced by using a compound represented by the formula (4) below (hereinafter sometimes referred to as “compound (4)”) as the aromatic dihalogenosulfone compound, and by using a compound represented by the formula (5) below (hereinafter sometimes referred to as “compound (5)”) as the aromatic dihydroxy compound. In addition, a resin having the repeating unit (1) and the repeating unit (2) can be suitably produced by using the compound (4) as the aromatic dihalogenosulfone compound, and by using a compound represented by the formula (6) below (hereinafter sometimes referred to as “compound (6)”) as the aromatic dihydroxy compound. Moreover, a resin having the repeating unit (1) and the repeating unit (3) can be suitably produced by using the compound (4) as the aromatic dihalogenosulfone compound, and by using a compound represented by the formula (7) below (hereinafter sometimes referred to as “compound (7)”) as the aromatic dihydroxy compound.

X¹-Ph¹-SO₂-Ph²-X² (4)

X¹ and X² each independently represents a halogen atom. Ph¹ and Ph² are as defined above.

HO-Ph¹-SO₂-Ph²-OH (5)

Ph¹ and Ph² are as defined above.

HO-Ph³-R-Ph⁴-OH (6)

Ph³, Ph⁴ and R are as defined above.

HO-(Ph⁵)ₙ-OH (7)

Ph⁵ and n are as defined above.

Examples of the compound (4) include bis(4-chlorophenyl) sulfone and 4-chlorophenyl-3′,4′-dichlorophenyl sulfone. Examples of the compound (5) include bis(4-hydroxyphenyl) sulfone, bis(4-hydroxy-3,5-dimethylphenyl) sulfone, and bis(4-hydroxy-3-phenylphenyl) sulfone. Examples of the compound (6) include 2,2-bis(4-hydroxyphenyl)propane, 2,2-bis(4-hydroxyphenyl)hexafluoropropane, bis(4-hydroxyphenyl) sulfide, bis(4-hydroxy-3-methylphenyl) sulfide, and bis(4-hydroxyphenyl)ether. Examples of the compound (7) include hydroquinone, resorcin, catechol, phenylhydroquinone, 4,4′-dihydroxybiphenyl, 2,2′-dihydroxybiphenyl, 3,5,3′,5′-tetramethyl-4,4′-dihydroxybiphenyl, 2,2′-diphenyl-4,4′-dihydroxybiphenyl, and 4,4′″-dihydroxy-p-quarterphenyl.

An example of the aromatic dihalogenosulfone compound other than the compound (4) includes 4,4′-bis(4-chlorophenylsulfonyl) biphenyl. In addition, in place of all or part of the aromatic dihalogenosulfone compound and/or the aromatic dihydroxy compound, a compound having a halogeno group and a hydroxyl group in the molecule such as 4-hydroxy-4′-(4-chlorophenylsulfonyl) biphenyl may also be used.

The alkali metal salt of carbonic acid may be alkali carbonate which is a normal salt, alkali bicarbonate (hydrogen alkali carbonate) which is an acidic salt, or a mixture thereof. Sodium carbonate and potassium carbonate are preferably used as the alkali carbonate, and sodium bicarbonate and potassium bicarbonate are preferably used as the alkali bicarbonate.

Examples of the organic polar solvent include dimethyl sulfo de, 1-methyl-2-pyrrolidone, sulfolane (1,1-dioxothilan), 1,3-dimethyl-2-imidazolidinone, 1,3-diethyl-2-imidazolidinone, dimethyl sulfone, diethyl sulfone, diisopropyl sulfone, and diphenyl sulfone.

The amount of the aromatic dihalogenosulfone compound used is usually 95-110 mol %, and preferably 100-105 mol % relative to the aromatic dihydroxy compound. The desired reaction is a dehydrohalogenation polycondensation of the aromatic dihalogenosulfone compound and the aromatic dihydroxy compound. If no side reaction occurs, as the molar ratio of both approaches 1:1—that is, as the amount of the aromatic dihalogenosulfone compound used approaches 100 mol % relative to the aromatic dihydroxy compound—the degree of polymerization of the resulting aromatic polysulfone resin tends to increase, with the result that reduced viscosity tends to increase. However, in reality, a side reaction such as depolymerization or a substitution reaction to a hydroxyl group of a halogeno group occurs due to alkali hydroxide and the like that is produced as a by-product, and the degree of polymerization of the resulting aromatic polysulfone resin decreases due to this side reaction. Therefore, taking into consideration also the degree of this side reaction, it is necessary to adjust the amount of the aromatic dihalogenosulfone compound used so that aromatic polysulfone resin is obtained which has the aforementioned prescribed reduced viscosity.

The amount of the alkali metal salt of carbonic acid used is usually 95-115 mol % as an alkali metal relative to the hydroxyl group of the aromatic dihydroxy compound, and 100-110 mol % is preferable. If no side reaction occurs, as the desired polycondensation rapidly progresses as the amount of alkali metal salt of carbonic acid used increases, the degree of polymerization of the resulting aromatic polysulfone resin tends to increase, with the result that reduced viscosity tends to increase. However, in reality, occurrence of the same side reaction mentioned above is facilitated as the amount of alkali metal salt of carbonic acid used increases, and the degree of polymerization of the resulting aromatic polysulfone resin decreases due to this side reaction. Therefore, taking into consideration also the degree of this side reaction, it is necessary to adjust the amount of the alkali metal salt of carbonic acid used so that aromatic polysulfone resin is obtained which has the aforementioned prescribed reduced viscosity.

In a typical method of producing aromatic polysulfone resin, an aromatic polysulfone resin is obtained by: dissolving an aromatic dihalogenosulfone compound and an aromatic dihydroxy compound in an organic polar solvent as a first step; adding an alkali metal salt of carbonic acid to the solution obtained in the first step, and polycondensing the aromatic dihalogenosulfone compound and the aromatic dihydroxy compound as a second step; and removing the unreacted alkali metal salt of carbonic acid, the by-product alkali halide, and the organic polar solvent from the reaction mixture obtained in the second step as a third step.

The dissolution temperature of the first step is usually 40-180° C. Moreover, the polycondensation temperature of the second step is usually 180-400° C. If no side reaction occurs, as the desired polycondensation rapidly progresses as polycondensation temperature increases, the degree of polymerization of the resulting aromatic polysulfone resin tends to increase, with the result that reduced viscosity tends to increase. However, in reality, occurrence of the same side reaction that was mentioned above is facilitated as polycondensation temperature increases, and the degree of polymerization of the resulting aromatic polysulfone resin decreases due to this side reaction. Therefore, taking into consideration also the degree of this side reaction, it is necessary to adjust polycondensation temperature so that aromatic polysulfone resin is obtained which has the aforementioned prescribed reduced viscosity.

With respect to the polycondensation of the second step, usually, the temperature gradually rises, and the reflux temperature of the organic polar solvent is reached while the by-product water is removed. Thereafter, it is usually advisable to conduct heat retention for a further 1-50 hours, and preferably 10-30 hours. If no side reaction occurs, as the desired polycondensation progresses as polycondensation time lengthens, the degree of polymerization of the resulting aromatic polysulfone resin tends to increase, with the result that reduced viscosity tends to increase. However, in reality, the same side reaction that was mentioned above also progresses as polycondensation time lengthens, and the degree of polymerization of the resulting aromatic polysulfone resin decreases due to this side reaction. Therefore, taking into consideration also the degree of this side reaction, it is necessary to adjust polycondensation time so that aromatic polysulfone resin is obtained which has the aforementioned prescribed reduced viscosity.

In the third step, first, a solution can be obtained in which aromatic polysulfone resin is dissolved in organic polar solvent by removing the unreacted alkali metal salt of carbonic acid and the by-product alkali halide from the reaction mixture obtained in the second step by filtration, centrifugation or the like. Next, aromatic polysulfone resin can be obtained from this solution by removing the organic polar solvent. Removal of the organic polar solvent may be conducted by directly distilling the organic polar solvent out of the aforementioned solution, or it may be conducted by mixing the aforementioned solution with a poor solvent of aromatic polysulfone resin, precipitating the aromatic polysulfone resin, and conducting separation by filtration, centrifugation or the like.

Examples of the poor solvents of aromatic polysulfone resin include methanol, ethanol, isopropyl alcohol, hexane, heptane, and water. Methanol is preferable, because it is easy to remove.

In the case where an organic polar solvent of comparatively high melting point is used as the polymerization solvent, after subjecting the reaction mixture obtained in the second step to cooling solidification, it is pulverized, and the unreacted alkali metal salt of carbonic acid and the by-product alkali halide are extracted and removed from the obtained powder using water, and the organic polar solvent can also be extracted and removed using a solvent which is not capable of dissolving aromatic polysulfone resin, but which is capable of dissolving an organic polar solvent.

From the standpoint of extraction efficiency and work performance during extraction the volume average particle size of the aforementioned powder is preferably 200-2000 μm, more preferably 250-1500 μm, and still more preferably 300-1000 μm. If too large, there is the undesirable result that extraction efficiency is poor, and if too small, there is the undesirable result that consolidation occurs during extraction, and that clogging occurs during the filtration and drying that follows extraction.

As the extraction solvent, a mixed solvent of acetone and methanol may be used when, for example, diphenyl sulfone is used as the polymerization solvent. Here, the mixing ratio of acetone and methanol is usually determined based on extraction efficiency and adherence of the aromatic polysulfone resin powder.

In another typical method of producing aromatic polysulfone resin, an aromatic dihydroxy compound and alkali metal salt of carbonic acid are reacted in an organic polar solvent, and the water that is produced as a by-product is removed as a first step; an aromatic dihalagenosulfone compound is added to the reaction mixture obtained in the first step, and polycondensation is conducted as a second step; and the unreacted alkali metal salt of carbonic acid, the by-product alkali halide, and the organic polar solvent are removed from the reaction mixture obtained in the second step in the same manner as above to obtain aromatic polysulfone resin as a third step.

With respect to this alternative method, in the first step, azeotropic dehydration may also be conducted by adding an organic solvent that is azeotropic with water in order to remove the by-product water. Examples of the organic solvent that is azeotropic with water include benzene, chlorobenzene, toluene, methyl isobutyl ketone, hexane, and cyclohexane. The temperature of the azeotropic dehydration is usually 70-200° C.

In this alternative method, the polycondensation temperature of the second step is usually 40-180° C., and it is necessary to adjust polycondensation temperature and polycondensation time taking into account also the degree of side reaction as mentioned above so as to obtain aromatic polysulfone resin which has the aforementioned prescribed reduced viscosity.

Examples of the hydrophilic polymer include polyalkyleneglycols such as polyvinylpyrrolidone, polyethyleneglycol, and polypropyleneglycol; polyhydroxyalkyl (meth)acrylates such as polyvinyl alcohol, polyhydroxyethyl acrylate, and polyhydroxyethyl methacrylate; polyacrylamide; and polyethylenimine. Two or more of these may be used as necessary. Among these, it is preferable when polyvinylpyrrolidone—particularly high-molecular-weight polyvinylpyrrolidone with a molecular weight of 1 to 3 million—is used, because even a small amount can increase the viscosity enhancement effect of the aforementioned solution.

The amount of hydrophilic polymer used is usually 5-40 parts by weight, and preferably 15-30 parts by weight, relative to 100 parts by weight of aromatic polysulfone resin. When the amount of hydrophilic polymer used is excessively small, the porous membrane that is obtained has insufficient water permeability, and when it is too large, the porous membrane that is obtained has insufficient heat resistance and solvent resistance, as well as insufficient strength and chemical resistance.

The porous membrane of the present invention which contains aromatic polysulfone resin having the aforementioned prescribed reduced viscosity and hydrophilic polymer may, for example, be flat film, tubular film, or hollow-fiber membrane. The porous membrane of the present invention may be a monolayer film, or a multilayer film. In the case of multilayer film, it may be a multilayer film which has two or more layers containing only aromatic polysulfone resin having the aforementioned prescribed reduced viscosity and hydrophilic polymer, or it may be a multilayer film which has one or more layers containing aromatic polysulfone resin having the aforementioned prescribed reduced viscosity and hydrophilic polymer, and one or more other layers.

With respect to manufacture of the porous membrane, a known method may be suitably adopted. For example, manufacture may be conducted by a wet-and-dry method where the aromatic polysulfone resin and hydrophilic polymer are dissolved in a solvent, and this solution is extruded into a prescribed form with interposition of an air gap, or by a wet method without interposition of an air gap, and with introduction into a solidification liquid, phase separation, and desolvation. Or it may be conducted by dissolving the aromatic polysulfone resin and hydrophilic polymer in a solvent, casting this solution into a base material of prescribed form, immersing it in a solidification liquid, and conducting phase separation and desolvation.

In the case where hollow-fiber membrane is manufactured as the porous membrane, preferably, the aforementioned solution is used as the spinning stock solution, a double-ring nozzle of the core-sheath type is used to discharge the aforementioned solution from the sheath side, while a solidification liquid (hereinafter sometimes referred to as “internal solidification liquid”) or gas is discharged from the core side, and these are introduced into a solidification liquid (hereinafter sometimes referred to as “external solidification liquid”) with or without interposition of an air gap.

Examples of the good solvent of aromatic polysulfone resin used in preparation of the aforementioned solution (hereinafter sometimes simply referred to as “good solvent”) include N-methylpyrrolidone, N,N-dimethylformamide, and N,N-dimethylacetoamide. The aforementioned solution may also contain components other than aromatic polyester resin, hydrophilic polymer, and good solvent—e.g., poor solvent of aromatic polysulfone resin (hereinafter sometimes simply referred to as “poor solvent”), and lubricants. When the aforementioned solution does not contain poor solvent or lubricants, it is preferable that N,N-dimethylacetoamide be used as good solvent.

Examples of the lubricants include ethyleneglycols such as ethyleneglycol, diethyleneglycol, and triethyleneglycol. Ethyleneglycol is preferable due to its ease of removal.

As solidification liquid, poor solvent or mixed solvent of poor solvent and good solvent may be used, but it is preferable when a mixed solvent of poor solvent and good solvent is used as the solidification liquid, because it is possible to adjust pore diameter and pore diameter distribution of the obtained porous membrane by adjusting the mixing ratio thereof. In particular, these effects can be efficiently engendered when using a mixed solvent composed of water which is the poor solvent and N,N-dimethylacetoamide which is the good solvent in both the internal solidification liquid and the external solidification liquid. By using this mixed solvent, the subsequent solvent recovery can be easily conducted.

The resulting porous membrane may be subjected to heat treatment or radiation treatment as necessary in order to perform insolubilization treatment on the hydrophilic polymer in the porous membrane. By conducting heat treatment or radiation treatment, the hydrophilic polymer crosslinks, and fixates within the porous membrane, thereby enabling prevention of elution of the hydrophilic polymer in the filtrate when the porous membrane is used as a filtration membrane.

It is preferable that the heat treatment or radiation treatment be conducted within a scope that does not markedly change the porous membrane in terms of its form, structure, mechanical properties or the like, and under conditions that are sufficient for cross-linking of the hydrophilic polymer. Either treatment may be conducted alone, or both treatments may be conducted.

For example, heat treatment for a porous membrane that is manufactured using polyvinylpyrrolidone as the hydrophilic polymer is preferably conducted at a treatment temperature of 150-190° C., and treatment time is suitably set according to the amount of polyvinylpyrrolidone in the porous membrane.

Radiation treatment of the porous membrane can be conducted using α-rays, β-rays, γ-rays, X-rays or electron rays as the radiation. In this case, it is possible to effectively prevent damage to the porous membrane by conducting the treatment under conditions where the porous membrane has been impregnated with water containing antioxidants.

Examples of the present invention are shown below, but the present invention is not limited thereto.

### EXAMPLES

### Measurement of Reduced Viscosity of Aromatic Polysulfone Resin

Approximately 1 g of aromatic polysulfone resin was dissolved in N,N-dimethylformamide, with capacity set at 1 dL, and the viscosity (η) of this solution was measured at 25° C. using an Ostwald-type viscosity tube. The viscosity (η₀) of the N,N-dimethylformamide which was the solvent was also measured at 25° C. using an Ostwald-type viscosity tube. The specific viscosity coefficient ((η−η₀)/η₀) was obtained from the viscosity (η) of the aforementioned solution and the viscosity (η₀) of the aforementioned solvent. The reduced viscosity (dL/g) of the aromatic polysulfone resin was obtained by dividing this specific viscosity coefficient by the concentration of the aforementioned solution (approximately 1 g/dL).

### Production Example 1

A polymerization tank provided with a condenser equipped with an agitator, a nitrogen inlet tube, a thermometer, and a receiver at its distal end was charged with 500 g of bis(4-hydroxyphenyl) sulfone, 589 g of bis(4-chlorophenyl) sulfone and 942 g of diphenyl sulfone as the polymerization solvent, and heated to a temperature of 180° C. while circulating nitrogen gas through the system. After adding 287 g of potassium carbonate to the obtained solution, the temperature was gradually raised to 290° C., and reaction was conducted for a further two hours at 290° C. After the obtained reaction solution was cooled to room temperature to be solidified, and was finely pulverized, washing with hot water and washing with a mixed solvent of acetone and methanol were conducted several times, and drying by heating was then conducted at 150° C. to obtain aromatic polysulfone resin terminated by a chloro group as powder. As a result of measurement, the reduced viscosity of this aromatic polysulfone resin was 0.59 dL/g.

### Production Example 2

A polymerization tank provided with a condenser equipped with an agitator, a nitrogen inlet tube, a thermometer, and a receiver at its distal end was charged with 500 g of bis(4-hydroxyphenyl) sulfone, 585 g of bis(4-chlorophenyl) sulfone and 936 g of diphenyl sulfone as the polymerization solvent, and heated to a temperature of 180° C. while circulating nitrogen gas through the system. After adding 289 g of potassium carbonate to the obtained solution, the temperature was gradually raised to 290° C., and reaction was conducted for a further two hours at 290° C. After the obtained reaction solution was cooled to room temperature to be solidified, and finely pulverized, washing with hot water and washing with a mixed solvent of acetone and methanol were conducted several times, and drying by heating was then conducted at 150° C. to obtain aromatic polysulfone resin terminated by a chloro group as powder. As a result of measurement, the reduced viscosity of this aromatic polysulfone resin was 0.76 dL/g.

### Production Example 3

A polymerization tank provided with a condenser equipped with an agitator, a nitrogen inlet tube, a thermometer, and a receiver at its distal end was charged with 500 g of bis(4-hydroxyphenyl) sulfone, 598 g of bis(4-chlorophenyl) sulfone and 957 g of diphenyl sulfone as the polymerization solvent, and heated to a temperature of 180° C. while circulating nitrogen gas through the system. After adding 287 g of potassium carbonate to the obtained solution, the temperature was gradually raised to 290° C., and reaction was conducted for a further two hours at 290° C. After the obtained reaction solution was cooled to room temperature to be solidified, and finely pulverized, washing with hot water and washing with a mixed solvent of acetone and methanol were conducted several times, and drying by heating was then conducted at 150° C. to obtain aromatic polysulfone resin terminated by a chloro group as powder. As a result of measurement, the reduced viscosity of this aromatic polysulfone resin was 0.36 dL/g.

### Example 1

The aromatic polysulfone resin obtained in Production Example 1 (reduced viscosity: 0.59 dL/g) and polyvinylpyrrolidone (“K-90” manufactured by ISP Co.) as the hydrophilic polymer were dissolved in N,N-dimethylacetoamide so that the concentration of aromatic polysulfone resin was 12 weight %, and that of polyvinylpyrrolidone was 3 weight %. This solution was used as the spinning stock solution, and was discharged from the sheath side of the double-ring nozzle, and a mixed solvent of water/N,N-dimethylacetoamide=30/70 (weight ratio) was used as the internal solidification liquid, and was discharged from the core side of the double-ring nozzle.

After once transiting 10 mm in the air, the discharge was channeled into the external solidification liquid which was a mixed solvent of water/N,N-dimethylacetoamide=50/50 (weight ratio) maintained at 50° C., where solidification was conducted. The obtained hollow-fiber membrane was wound on a bobbin, and was washed for three hours under running water with hot water of 80° C. to conduct solvent removal.

The obtained hollow-fiber membrane was reverse-cleaned by air, and was subsequently immersed in a 1 N sodium hydroxide aqueous solution, but no deterioration of fiber was observed.

### Example 2

Hollow-fiber membrane was manufactured in the same manner as Example 1, except that the aromatic polysulfone resin obtained in Production Example 2 (reduced viscosity: 0.59 dL/g) was used, instead of the aromatic polysulfone resin obtained in Production Example 1.

The obtained hollow-fiber membrane was reverse-cleaned by air, and was subsequently immersed in a 1 N sodium hydroxide aqueous solution, but no deterioration of fiber was observed.

### Comparative Example 1

Hollow-fiber membrane was manufactured in the same manner as Example 1, except that the aromatic polysulfone resin obtained in Production Example 3 (reduced viscosity: 0.36 dL/g) was used, instead of the aromatic polysulfone resin obtained in Production. Example 1.

The obtained hollow-fiber membrane was reverse-cleaned by air, and was subsequently immersed in a 1 N sodium hydroxide aqueous solution, and partial deterioration of fiber was observed.

### INDUSTRIAL APPLICABILITY

By using aromatic polysulfone resin and hydrophilic polymer as its material, the porous membrane of the present invention not only has excellent heat resistance, solvent resistance and water permeability, but is also high in strength and chemical resistance, enabling it to withstand physical cleaning and chemical cleaning, and may therefore be suitably used in aqueous fluid filtration such as ultrafiltration and microfiltration.

1. A porous membrane, comprising aromatic polysulfone resin that has a reduced viscosity of 0.56-0.78 dL/g, and a hydrophilic polymer.

2. The porous membrane according to claim 1, wherein a reduced viscosity of the aromatic polysulfone resin is 0.65-0.78 dL/g.

3. The porous membrane according to claim 1, wherein a reduced viscosity of the aromatic polysulfone resin is 0.70-0.78 dL/g.

4. The porous membrane according to claim 1, wherein the aromatic polysulfone resin is resin which has a repeating unit represented by the following formula (1):
-Ph¹-SO₂-Ph²-O— (1)
wherein Ph¹ and Ph² each independently represents a phenylene group, and hydrogen atoms of the phenylene groups may each be independently substituted with an alkyl group, an aryl group, or a halogen atom.

5. The porous membrane according to claim 1, wherein the hydrophilic polymer is polyvinylpyrrolidone.

6. The porous membrane according to claim 1, which is a hollow-fiber membrane.
